(19) United States
(12) Patent Application Publication
(10) Pub. No.: US 2014/0207283 A1
(43) Pub. Date: Jul. 24, 2014

(54) ROBOT WITH HANDLING UNIT

(71) Applicant: Weber Maschinenbau GmbH, Breidenbach (DE)

(72) Inventor: Christoph Kuhmichel, Bad Berleburg (DE)

(73) Assignee: Weber Maschinenbau GmbH, Breidenbach (DE)

(21) Appl. No.: 14/149,522

(22) Filed: Jan. 7, 2014

(30) Foreign Application Priority Data
Jan. 22, 2013 (DE) 10 2013 001 110.8

(51) Int. Cl. B25J 9/16

(52) U.S. Cl. CPC B25J 9/1633
USPC 700/258

(57) ABSTRACT

The disclosure relates to a robot for picking up a food product from a support and for shifting it to a desired location, said robot comprising at least one robot arm with a handling unit for picking up the food product, and the food product being displaceable by moving the handling unit by means of the robot arm. The robot arm and the handling unit have provided between them a sensor, in particular a force sensor, with the aid of which the force acting between the robot arm and the handling unit can be detected in at least one direction. The invention additionally relates to a method of operating a robot for shifting a food product.

### CROSS-REFERENCE TO RELATED APPLICATIONS

This application claims priority to German Patent Application 10 2013 001 110.8 filed on Jan. 22, 2013, which is hereby incorporated by reference in its entirety.

### TECHNICAL FIELD

The disclosure relates to a robot according to the preamble of the main claim. Such a robot is known e.g. from European patent 2 168 892. For picking and placing the product, a robot arm is used, which is provided with a handling unit in the form of a gripper.

### BACKGROUND

Robots are very useful for automatically handling products during a production process, since they normally operate quickly and reliably. It may, however, happen that malfunctions occur in the motion sequences of the robot, which, in the worst case, lead to a malfunction of the robot. Such malfunctions may be mechanical obstacles. In order to limit the damage caused in the event of mechanical malfunctions, the robot arm or the handling unit may e.g. fragment when it meets an obstacle. This, however, means that operational procedures will be interrupted.

### SUMMARY

It is the object of the present disclosure to provide a robot of the type specified at beginning, in the case of which the physical damage as well as the interruption of the operational procedure will be minimized simply and reliably in the event of a collision.

According to the present disclosure, this object is achieved by the characterizing clause of the main claim. The sensor serves several purposes. It may be configured as a force and/or acceleration sensor. On the one hand, it may be used for achieving smooth picking up and also smooth shifting and depositing of the food product. On the other hand, the sensor also serves to minimize influences originating from collisions. It measures the forces acting thereon during the motion sequences. Control commands can be derived so as to perform picking up, acceleration during shifting and deposition as carefully as possible.

In the event of a collision, the sensor detects the disturbance variable and determines immediate switching off of the motion processes. A destruction of mechanical, electrical, electronic and other parts of the robot is thus prevented.

The sensor may additionally also be used for weighing the food. It is also imaginable to use it for supervising and adjusting the contact pressure of the handling unit on the support. In practice this means that, when the handling unit is moved into contact with the support, the handling unit and the respective grippers can be controlled such that they approach and move to the optimum gripping position with precision. This can be done by programming the robot or by “self-learning” on the part of the robot.

According to a further development of the disclosure, the sensor detects horizontal and/or vertical force components and/or accelerations.

The sensor may be arranged in a separate reception element associated with the robot arm. A releasable arrangement of the handling unit and of the sensor is preferred.

The sensor may be part of a sensor unit capable of recording by means of a data memory the signals ascertained by the sensor and the associated time.

The sensor unit may be configured for calculating the accumulated mechanical loads on the robot from the force/time curve and for indicating adequate maintenance intervals.

The handling unit used may be a gripper, which engages the food product from below. The robot may be a delta robot.

The object specified at the beginning is also achieved by a method comprising the following steps:
picking up the food product by means of a handling unit provided on a robot arm,
moving the handling unit by means of the robot arm so that the food product is shifted to a desired location, and
depositing the food product.

The disclosure is so conceived that the force acting between the robot arm and handling unit is detected in one direction. This applies especially to the moment at which the handling unit touches down on the support of the food product. The aim to be achieved here is minimizing the touch-down force of the handling unit and of the associated gripper during touching down. In order to optimize the motion sequences and avoid damage caused by malfunctions, it will be advantageous to stop the movement of the robot if the force ascertained by the sensor exceeds a limit value. The force/time curve recorded by the data memory can be used for configuring the mechanical stability of the robot.

The disclosure is described making reference to the following figures.

### BRIEF DESCRIPTION OF THE DRAWINGS

FIG. 1 shows a schematic side view of a robot whose handling unit meets an obstacle and

FIG. 2 shows a side view of the robot according to FIG. 1 with a food product engaged from below.

### DETAILED DESCRIPTION

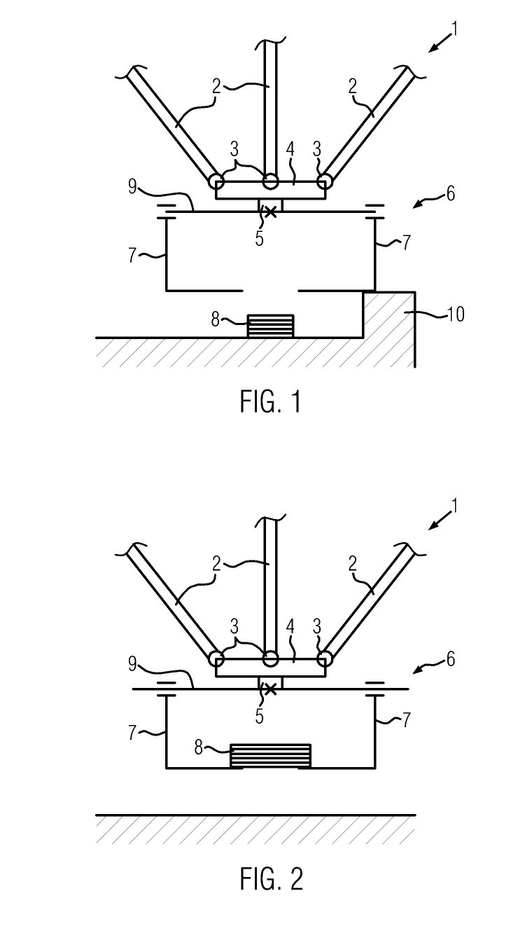

The robot 1 shown in FIG. 1 is normally referred to as a delta robot. It is provided with three robot arms 2 whose lower ends are connected via joints 3 to a base plate 4, which serves as a reception element. The base plate 4 has arranged thereon e.g. a force sensor 5 representing part of a sensor unit, which is not shown and which comprises a data memory, an evaluation unit etc., among other elements.

The force sensor 5 has secured thereto a handling unit 6, which is intended to grip a food product 8 by means of a gripper 7.

In the present case, the force sensor 5 has arranged thereon a horizontal support 9 on which the grippers 7 are supported in a horizontally displaceable manner. The grippers themselves are configured as angular carriers, which are able to move horizontally towards one another so as to grip the food product 8. When the food product is put down, the grippers move apart.

The robot, together with its parts, is only schematically shown in FIGS. 1 and 2. A great variety of embodiments can be used for the robot arms, the joints, the base plate etc. The disclosure is not limited to these schematic representations.

The robot 1 serves to pick up the food product 8 and to shift it from the pick-up position to a depositing position, which is not shown. To this end, the robot is controlled such that the grippers 7 of the handling unit 6 approach the food product from above or from the side and engage the product from below as gently as possible so as to locally displace it afterwards by a movement of the handling unit.

The force sensor 5 is located between the robot 1 and the handling unit 6 and is thus able to detect the motion sequence of the robot as well as that of the handling unit 6 and of the food product 8 engaged from below by the latter. The force sensor may ascertain all force components in X, Y, Z directions, or it may be configured such that it detects only specific force components. It transmits its measurement values preferably to its sensor unit, which may be configured in an arbitrary manner. It may include a data memory, an evaluation unit, a display unit etc. With the aid of the data memory, the measurement values ascertained by the force sensor can be evaluated in various respects. A force/time diagram may, for example, be created. The force sensor can be used not only for supervising the motion sequence of the robot but also for optimizing the production and the gentleness of picking up and depositing the food product as well as for detecting malfunctions.

In FIG. 1 such a malfunction is shown symbolically. The right gripper 7 knocks against an obstacle 10. The force sensor 5 detects this obstacle, e.g. when the force ascertained thereby exceeds a limit value, whereby the malfunctioning in question is perceived.

Due to the reaction of the force sensor, the further movement of the robot and of its arms and the handling unit, respectively, can be stopped. The robot and its parts are prevented from being damaged.

However the force sensor may not only be used for supervising and checking the motion sequence of the robot and the production, respectively, but also for detecting wear and damage that may have been caused to the robot parts. It is thus used for collision detection as well as for damage accumulation and indicates e.g. when maintenance will be due.

Finally, the sensor 5 may also serve to ascertain the weight of the food product by lifting the same or by measuring the acceleration. Last but not least, the values ascertained by the force sensor may additionally be used for checking and, if necessary, changing the mechanical stability of the robot, so as to improve its use.

1. A robot for picking up a food product from a support and for shifting it to a desired location, said robot comprising
at least one robot arm having provided thereon a handling unit which is configured for picking up the food product,
the food product being displaceable by moving the handling unit by means of the robot arm,
characterized in that
the robot arm and the handling unit have provided between them a sensor, in particular a force sensor, with the aid of which the force acting between the robot arm and the handling unit can be detected in at least one direction.

2. The robot according to claim 1, wherein the sensor is adapted to detect a vertical and/or horizontal force component and/or acceleration.

3. The robot according to claim 1, wherein the sensor is configured for detecting the force and/or the acceleration in the vertical direction and in at least one horizontal direction.

4. The robot according to claim 1, wherein the sensor is fixedly arranged on a reception element having arranged thereon at least one robot arm, the handling unit being releasably fixed to the force sensor.

5. The robot according to claim 1, wherein a sensor unit is provided, which includes a data memory, said sensor unit being configured for recording in the data memory the profile of the signal ascertained by the sensor over time.

6. The robot according to claim 5, wherein the sensor unit is configured for calculating the accumulated mechanical loads on the robot from the force/time curve and indicate adaptive maintenance intervals in a suitable way.

7. The robot according to claim 1, wherein the handling unit is a gripper unit engaging the food product from below.

8. The robot according to claim 1, wherein the robot is a delta robot.

9. A method of operating a robot for shifting a food product, said method comprising:
i) picking up the food product by means of a handling unit provided on a robot arm,
ii) moving the handling unit by means of the robot arm so that the food product is shifted to a desired location, and
iii) depositing the food product,
characterized by
detecting in at least one direction the force and/or acceleration acting between the robot arm and the handling unit.

10. The method according to claim 9, characterized by detecting the force when the handling unit touches down on a food-product providing unit.

11. The method according to claim 9 or 10, characterized by detecting the force during acceleration of the handling unit and ascertaining the weight of the food product from this force.

12. The method according to one of the claim 9, characterized by stopping the movement of the robot if the force and/or acceleration ascertained exceeds a limit value.

13. The method according to one of the claim 9, wherein the trajectory of the handling unit is adapted depending on the force ascertained.

14. The method according to one of the claim 9, wherein the force ascertained over time is recorded.

15. The method according to claim 14, wherein the force/time curve is used for configuring the mechanical stability of the robot.
